(19) United States
(12) Patent Application Publication
(10) Pub. No.: US 2024/0104432 A1
(43) Pub. Date: Mar. 28, 2024

(54) NOISY ECOLOGICAL DATA ENHANCEMENT VIA SPATIOTEMPORAL INTERPOLATION AND VARIANCE MAPPING

(71) Applicant: X Development LLC, Mountain View, CA (US)

(72) Inventor: Haoyu Zhang, Mountain View, CA (US)

(21) Appl. No.: 18/334,215

(22) Filed: Jun. 13, 2023

Related U.S. Application Data
(60) Provisional application No. 63/376,833, filed on Sep. 23, 2022.

(51) Int. Cl. G06N 20/00

(52) U.S. Cl. CPC G06N 20/00

(57) ABSTRACT

In some embodiments, a computer-implemented method of training and using a machine learning model is provided. A computing system receives a plurality of sampling data values for a geographical area. The computing system creates an interpolated value map and a variance map for the geographical area using the plurality of sampling data values. The computing system trains a machine learning model using values of the interpolated value map as ground truth values and evaluating performance of the machine learning model using the variance map. The computing system stores the trained machine learning model in a model data store.

### CROSS-REFERENCE TO RELATED APPLICATION

This application claims the benefit of Provisional Application No. 63/376,833, filed Sep. 23, 2022, the disclosure of which is hereby incorporated by reference herein in its entirety for all purposes.

### TECHNICAL FIELD

This disclosure relates generally to machine learning, and in particular but not exclusively, relates to training machine learning models using noisy data.

### BACKGROUND

Many techniques exist for training machine learning models. However, the quality of predictions generated by such models, and indeed whether the model ever even converges during training, can depend on the quality of the training data. If the training data is sparse or has a great deal of noise, then it becomes difficult, if not impossible, to train an effective machine learning model. This is a particularly common issue when training deep learning models based on ecological data including, but not limited to, insect population data captured using techniques such as pheromone traps. Such ecological data is difficult to collect and so tends to be sparse, and is also known to be noisy. What is needed are techniques that allow deep learning and other machine learning models to be reliably trained to generate predictions using noisy, sparse training data such as ecological data.

### BRIEF SUMMARY

In some embodiments, a computer-implemented method of training and using a machine learning model is provided. A computing system receives a plurality of sampling data values for a geographical area. The computing system creates an interpolated value map and a variance map for the geographical area using the plurality of sampling data values. The computing system trains a machine learning model using values of the interpolated value map as ground truth values and evaluating performance of the machine learning model using the variance map. The computing system stores the trained machine learning model in a model data store.

In some embodiments, a non-transitory computer-readable medium having computer-executable instructions stored thereon is provided. The instructions, in response to execution by one or more processors of a computing system, cause the computing system to perform actions for training and using a machine learning model, the actions comprising: receiving, by the computing system, a plurality of sampling data values for a geographical area; creating, by the computing system, an interpolated value map and a variance map for the geographical area using the plurality of sampling data values; training, by the computing system, a machine learning model using values of the interpolated value map as ground truth values and evaluating performance of the machine learning model using the variance map; and storing, by the computing system, the trained machine learning model in a model data store.

### BRIEF DESCRIPTION OF THE SEVERAL VIEWS OF THE DRAWINGS

Non-limiting and non-exhaustive embodiments of the invention are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described. To easily identify the discussion of any particular element or act, the most significant digit or digits in a reference number refer to the figure number in which that element is first introduced.

FIG. 1 is a map that illustrates a non-limiting example embodiment of sampling data according to various aspects of the present disclosure.

FIG. 2 is a block diagram that illustrates aspects of a non-limiting example embodiment of a noisy training computing system according to various aspects of the present disclosure.

FIG. 3A-FIG. 3B are a flowchart that illustrates a non-limiting example embodiment of a method of training a machine learning model using noisy training data according to various aspects of the present disclosure.

FIG. 4A illustrates a non-limiting example embodiment of an interpolated value map and FIG. 4B illustrates a non-limiting example embodiment of a variance map corresponding to the interpolated value map, according to various aspects of the present disclosure.

### DETAILED DESCRIPTION

In embodiments of the present disclosure, techniques are provided that allow machine learning models to be trained to effectively generate predictions, even when trained on sampling data that is noisy and/or sparse. One field in which these techniques may be useful is in training machine learning models for use with ecological data including but not limited to species population data, since such predictions are highly desired yet the collection of ground truth data for training is time consuming, expensive, and subject to confounding factors beyond the control of researchers. This field should not be seen as limiting, however, and the techniques disclosed herein may be useful in other fields wherein the data exhibits a correlative structure as well, e.g., other fields that utilize spatial, temporal, or spatiotemporal data.

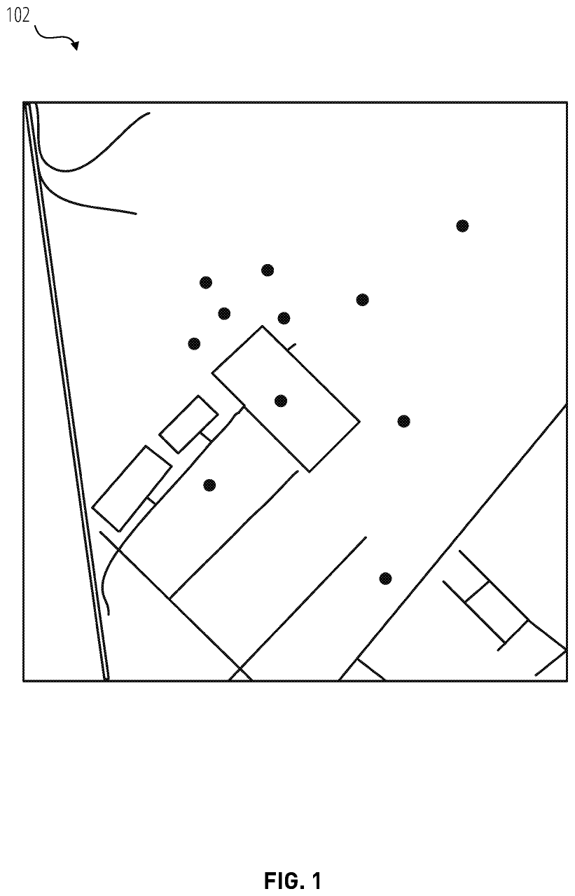

FIG. 1 is a map that illustrates a non-limiting example embodiment of sampling data according to various aspects of the present disclosure. Sampling data is typically collected using a sampling device deployed within a geographical area. In some embodiments, sampling devices may be arranged in a pattern to provide coverage throughout the geographical area, such as in a grid. In some embodiments, sampling devices may be arranged in convenient locations within the geographical area, such as on structures within the geographical area or attached to other equipment deployed within the geographical area. In some embodiments, sampling devices may be mobile and may collect sampling data while within the geographical area.

As shown the map with sampled data 102 includes a plurality of dots. Each dot is associated with a data sample. Typically, a data sample includes a sampled value and identifying information in one or more dimensions. In some embodiments, the sampled value represents the state being measured by the sampling device. In some embodiments, multiple data samples may be collected by the same sampling device and/or at the same location at different times.

Non-limiting example embodiments of a sampling device include a sticky trap or a pheromone trap used to collect insects. The sampled value may be collected by counting a number of insects of a species of interest that have been captured by the trap. The count may be performed manually and then entered into a computing device by a researcher, may be obtained automatically using a camera and a computer vision technique such as a convolutional neural network configured to recognize insects of the species of interest, or using any other suitable technique.

Another non-limiting example embodiment of a sampling device is a camera trap configured to capture images when motion is detected, and the sampled value may be collected by counting a number of animals of a species of interest in the image, either manually or using computer vision techniques. Yet another non-limiting example embodiment of a sampling device is a radio antenna configured to receive signals from radio transmitter tags worn by animals.

In some embodiments, the identifying information provides context, such as a location, to be associated with the sampled value. For example, the identifying information may include a latitude and a longitude (i.e., two-dimensional identifying information). As another example, the identifying information may include a latitude, a longitude, and a timestamp (i.e., three-dimensional identifying information). As yet another example, the identifying information may include a latitude, a longitude, an altitude, and a timestamp (i.e., four-dimensional identifying information). These examples should not be seen as limiting and in some embodiments, any number of dimensions, and/or any type(s) of dimensions, may be used for the identifying information. The timestamp may be recorded automatically if the sampling device automatically reports sampled values, or manually if the sampled values are collected manually.

While the map with sampled data 102 does appear to have a reasonably well-spread number of dots that represent data samples, aspects of the collection of the sampling data may inherently cause the sampling data to be noisy and/or sparse. For example, changing wind speeds, weather conditions, lighting conditions, human error, etc may cause some insect traps within the geographical area to capture a lower number of insects than is representative of the population in the geographical area overall, while the same conditions may cause other insect traps within the geographical area to capture a higher number of insects than is representative of the population in the geographical area overall.

Also, while merely averaging all of the sampled values may provide a reasonable estimation of the population within the geographical area as a whole, more detailed predictions are often desired (e.g., for a particular field or an area of a field, instead of for the geographical area overall) when determining actions to take for precision agricultural practices at specific locations that have not been sampled. Naïve averaging of neighboring points in order to generate interpolated values in locations that have not been sampled is likely to generate bad predictions due to confounding factors that may cause neighboring points to have a low amount of co-variance. For example, if the values are measuring populations of crawling pests, an intervening topographical feature such as a river, a canyon, or other barrier may make it unlikely that values on opposite sides of the feature will exhibit a high amount of co-variance.

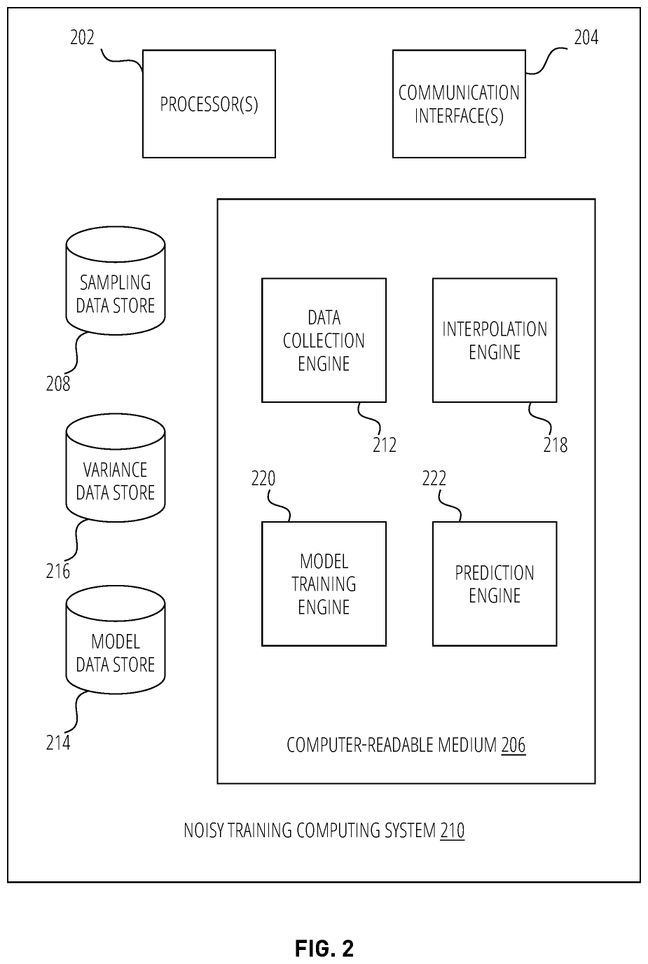

FIG. 2 is a block diagram that illustrates aspects of a non-limiting example embodiment of a noisy training computing system according to various aspects of the present disclosure. The illustrated noisy training computing system 210 may be implemented by any computing device or collection of computing devices, including but not limited to a desktop computing device, a laptop computing device, a mobile computing device, a server computing device, a computing device of a cloud computing system, and/or combinations thereof. The noisy training computing system 210 is configured to collect sampling data, which may be noisy or sparse when compared to ideal sampling data. The noisy training computing system 210 is configured to interpolate values based on the noisy sampling data using a technique that generates both interpolated values and indications of variance associated with the interpolated values. The noisy training computing system 210 may then train machine learning models using the interpolated values as ground truth data and using the variance to evaluate the performance of the models during training. One benefit of using these techniques is that the interpolated values have lower variance than the noisy sampling data, thus allowing the training of the models to have increased stability. Another benefit of using these techniques is that, by using the variance determined during interpolation for training, enhanced evaluation metrics may be used to better understand when the machine learning model is performing poorly because of low data confidence or because of low model confidence, thus allowing appropriate adjustments to the machine learning model to be made instead of over-adjusting in response to the noisy data.

As shown, the noisy training computing system 210 includes one or more processors 202, one or more communication interfaces 204, a sampling data store 208, a variance data store 216, a model data store 214, and a computer-readable medium 206.

In some embodiments, the processors 202 may include any suitable type of general-purpose computer processor. In some embodiments, the processors 202 may include one or more special-purpose computer processors or AI accelerators optimized for specific computing tasks, including but not limited to graphical processing units (GPUs), vision processing units (VPTs), and tensor processing units (TPUs).

In some embodiments, the communication interfaces 204 include one or more hardware and or software interfaces suitable for providing communication links between components. The communication interfaces 204 may support one or more wired communication technologies (including but not limited to Ethernet, FireWire, and USB), one or more wireless communication technologies (including but not limited to Wi-Fi, WiMAX, Bluetooth, 2G, 3G, 4G, 5G, and LTE), and/or combinations thereof.

As shown, the computer-readable medium 206 has stored thereon logic that, in response to execution by the one or more processors 202, cause the noisy training computing system 210 to provide a data collection engine 212, an interpolation engine 218, a model training engine 220, and a prediction engine 222.

As used herein, “computer-readable medium” refers to a removable or nonremovable device that implements any technology capable of storing information in a volatile or non-volatile manner to be read by a processor of a computing device, including but not limited to: a hard drive; a flash memory; a solid state drive; random-access memory (RAM); read-only memory (ROM); a CD-ROM, a DVD, or other disk storage; a magnetic cassette; a magnetic tape; and a magnetic disk storage.

In some embodiments, the data collection engine 212 is configured to receive sampling data generated using one or more sampling devices and to store the sampling data in the sampling data store 208. In some embodiments, the interpolation engine 218 is configured to generate interpolated values based on the sampling data, and to store the interpolated values in the variance data store 216. The interpolation engine 218 is also configured to generate variance values associated with the interpolated values, and to store the variance values in the variance data store 216. In some embodiments, the model training engine 220 is configured to use the interpolated values and the variance values to train one or more machine learning models, and to store the trained machine learning models in the model data store 214. In some embodiments, the prediction engine 222 is configured to use the trained machine learning models to generate predictions.

Further description of the configuration of each of these components is provided below.

As used herein, “engine” refers to logic embodied in hardware or software instructions, which can be written in one or more programming languages, including but not limited to C, C++, C #, COBOL, JAVA™, PHP, Perl, HTML, CSS, JavaScript, VBScript, ASPX, Go, and Python. An engine may be compiled into executable programs or written in interpreted programming languages. Software engines may be callable from other engines or from themselves. Generally, the engines described herein refer to logical modules that can be merged with other engines, or can be divided into sub-engines. The engines can be implemented by logic stored in any type of computer-readable medium or computer storage device and be stored on and executed by one or more general purpose computers, thus creating a special purpose computer configured to provide the engine or the functionality thereof. The engines can be implemented by logic programmed into an application-specific integrated circuit (ASIC), a field-programmable gate array (FPGA), or another hardware device.

As used herein, “data store” refers to any suitable device configured to store data for access by a computing device. One example of a data store is a highly reliable, high-speed relational database management system (DBMS) executing on one or more computing devices and accessible over a high-speed network. Another example of a data store is a key-value store. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, such as a hard disk drive, a flash memory, RAM, ROM, or any other type of computer-readable storage medium. One of ordinary skill in the art will recognize that separate data stores described herein may be combined into a single data store, and/or a single data store described herein may be separated into multiple data stores, without departing from the scope of the present disclosure.

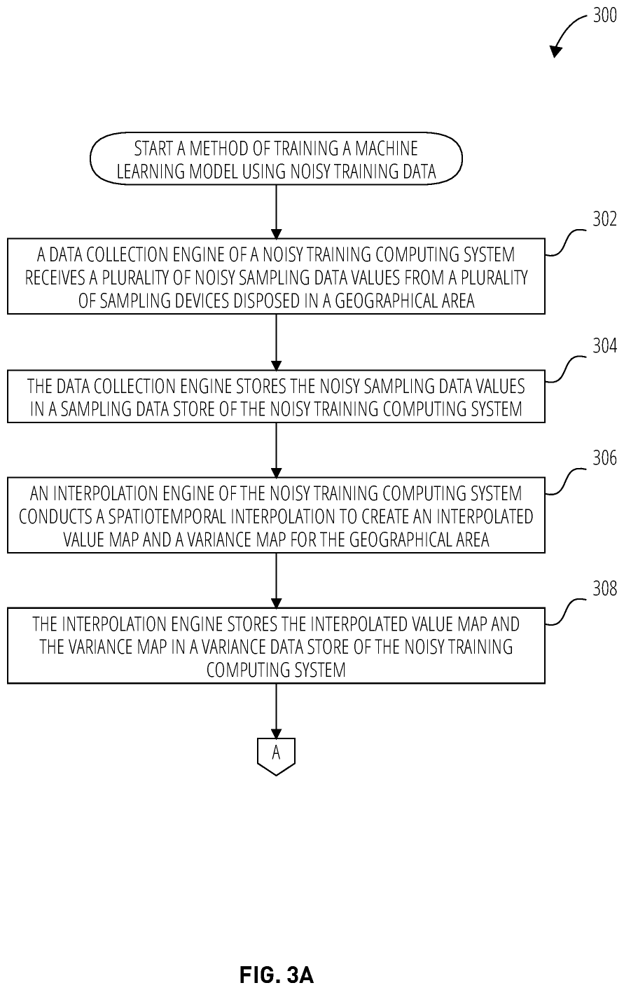

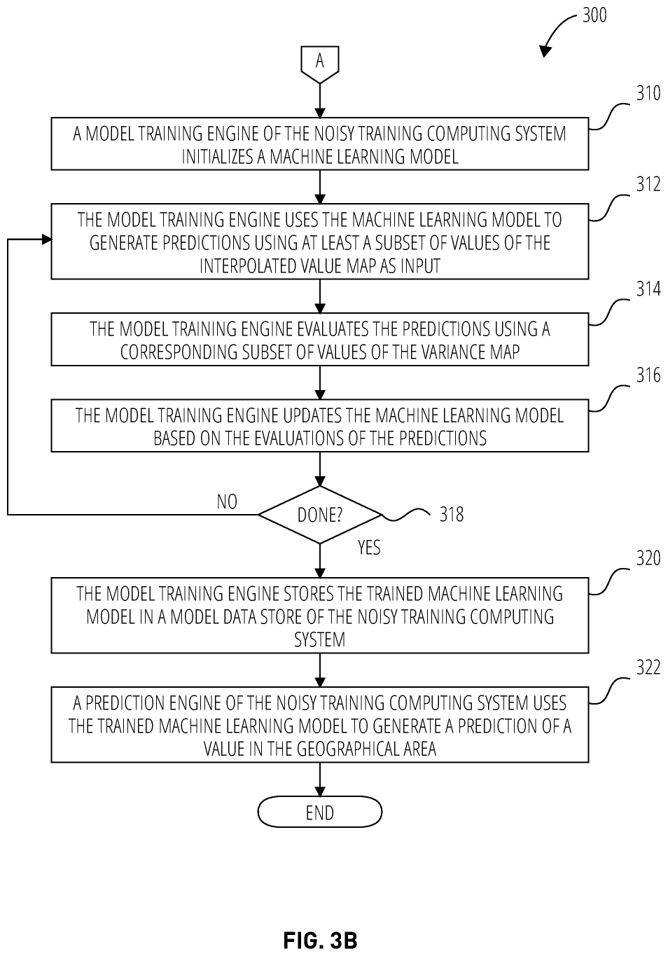

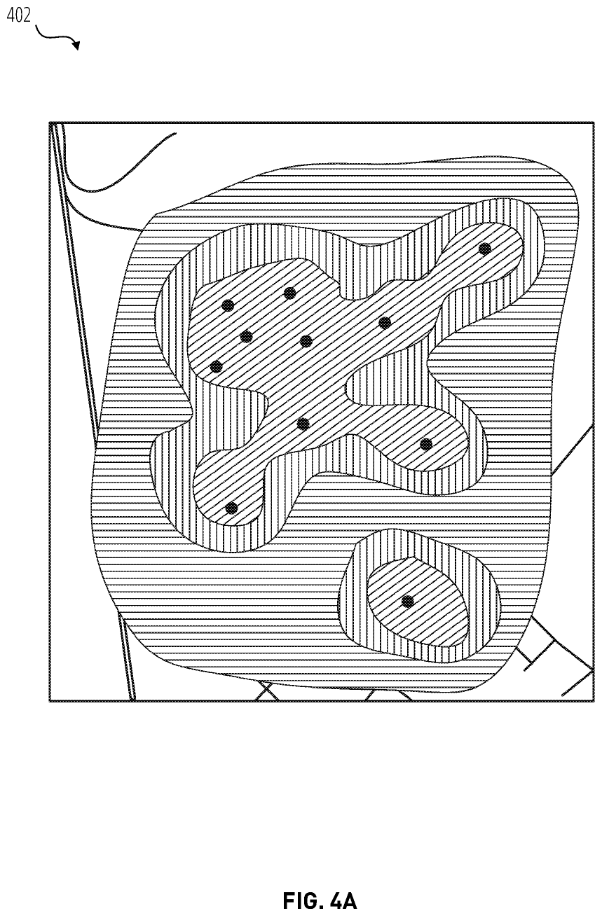

FIG. 3A-FIG. 3B are a flowchart that illustrates a non-limiting example embodiment of a method of training a machine learning model using noisy training data according to various aspects of the present disclosure. In order to compensate for noise in the training data, the method 300 uses an interpolation technique that generates an interpolated value map and an associated variance map that indicates an amount of confidence or variance in each interpolated value. The interpolated values are used as training input for a machine learning model, and the variance values of the variance map are used to evaluate performance of the machine learning model during optimization. By using the variance map during optimization of the machine learning model, the optimization process compensates for noise in the training data, and allows the machine learning model to be trained to generate accurate predictions.

From a start block, the method 300 proceeds to block 302, where a data collection engine 212 of a noisy training computing system 210 receives a plurality of noisy sampling data values from a plurality of sampling devices disposed in a geographical area, and at block 304, the data collection engine 212 stores the noisy sampling data values in a sampling data store 208 of the noisy training computing system 210. Any type of sampling data values may be collected from any type of sampling devices. As discussed above, in some embodiments, sampling data values may indicate a number of individual animals of a target species captured by a trap. In some embodiments, the sampling data values also include identifying information in one or more dimensions. In some embodiments, the dimensions of the identifying information may include one or more of a latitude, a longitude, and an altitude (or other values that represent a geographic position of the associated sampling device). In some embodiments, the dimensions of the identifying information may include a timestamp indicating a date and/or time at which the value was collected.

At block 306, an interpolation engine 218 of the noisy training computing system 210 conducts a spatiotemporal interpolation to create an interpolated value map and a variance map for the geographical area, and at block 308, the interpolation engine 218 stores the interpolated value map and the variance map in a variance data store 216 of the noisy training computing system 210. The spatiotemporal interpolation generates interpolated values along each of the dimensions of the identifying information. For example, if the identifying information includes latitude, longitude, and timestamp values, the spatiotemporal interpolation generates interpolated values at combinations of latitudes, longitudes, and timestamps that are not present in the noisy sampling data values, such as at a location that did not have a sampling device, or at a time between measurements that were collected, and so on.

Any suitable technique may be used for the spatiotemporal interpolation that creates both an interpolated value map and a variance map. Kriging, a technique commonly used in geostatistics but seldom, if ever, used for spatiotemporal interpolation of ecological data, is a non-limiting example of a suitable technique that creates both of these outputs. In simple kriging, the interpolated values are based on distances between the sampling data values (e.g., Euclidian distances between the points indicated by the identifying information) and a known (or estimated) covariance. In other types of kriging (e.g., ordinary kriging, universal kriging, etc), the distances and/or the characteristics of the data may be represented in different ways. The interpolated value map represents mean values predicted by the kriging operations, and the variance map represents variance around the mean values predicted by the kriging operations. For example, a mean value in the interpolated value map that is associated with neighboring sampling data values that are highly noisy or sparse may be associated with a high variance in the variance map, while a mean value in the interpolated value map that is associated with consistent sampling data values (or are very close to an actual sampling data value) may be associated with a low variance in the variance map.

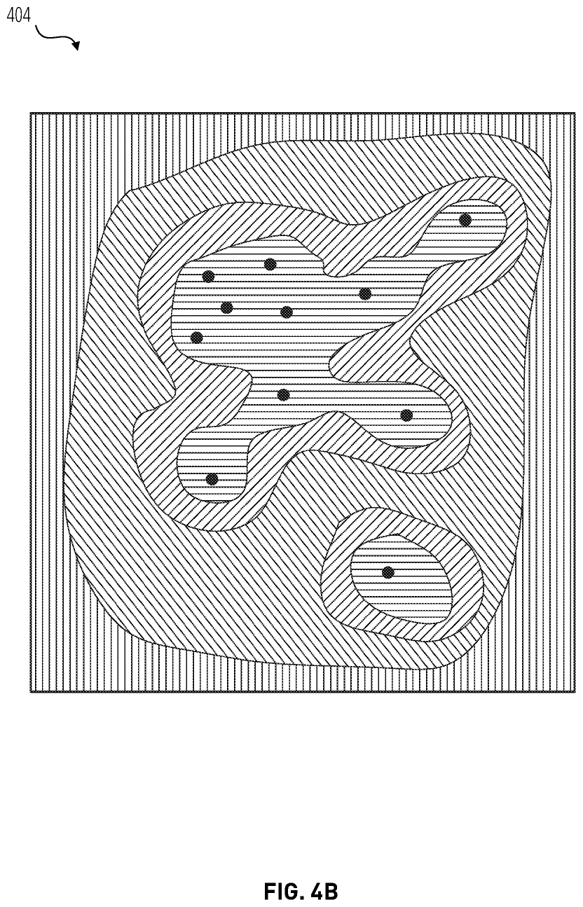

FIG. 4A illustrates a non-limiting example embodiment of an interpolated value map and FIG. 4B illustrates a non-limiting example embodiment of a variance map corresponding to the interpolated value map, according to various aspects of the present disclosure. The interpolated value map 402 and the variance map 404 are examples generated based on the map with sampled data 102 illustrated in FIG. 1. The interpolated value map 402 is illustrated as a heat map, with higher interpolated values depicted with different hashing for the sake of clarity. In some embodiments, the interpolated values are continuously variable instead of the illustrated discrete values. In the interpolated value map 402, values may be obtained at any point within the geographical area instead of merely at the dots that were present in FIG. 1. The variance map 404 is also illustrated as a heat map, with lower variance values (corresponding to higher confidence in the interpolated values) depicted with different hashing. As with the interpolated value map 402, the variance values are continuously variable instead of the illustrated discrete values. In this illustrative embodiment, the variance map 404 shows higher variance/lower confidence in areas that are not associated with sampling data values or are associated with fewer sampling data values. Though only illustrated in two dimensions for the sake of clarity, one of ordinary skill in the art will recognize that the interpolated value map 402 and the variance map 404 may include dimensions for each of the dimensions in the identifying information (e.g., may include a time dimension as well as the illustrated latitude and longitude).

Returning to FIG. 3A, the method 300 then proceeds to a continuation terminal (“terminal A”). From terminal A (FIG. 3B), the method 300 proceeds to block 310, where a model training engine 220 of the noisy training computing system 210 initializes a machine learning model. Any suitable type of machine learning model may be used, including but not limited to classification models, regression models, clustering models, and deep learning models. The machine learning model may use any suitable architecture, including but not limited to an artificial neural network architecture, a convolutional neural network architecture, a recurrent neural network architecture, a long short-term memory (LSTM) architecture, encoder/decoder architectures, and/or combinations thereof. The model training engine 220 may use any suitable technique for initializing the machine learning model, including but not limited to assigning random weights to parameters of the machine learning model, assigning default weights (e.g., a middle of a range of potential values for the weights, such as 0.5 on a scale of 0 to 1) to parameters of the machine learning model, assigning the weights of parameters of a previously trained machine learning model, or any other suitable technique.

At block 312, the model training engine 220 uses the machine learning model to generate predictions using at least a subset of values of the interpolated value map as input. In some embodiments, the machine learning model may be provided a subset of the interpolated values from the interpolated value map as input, and may provide predicted values (e.g., values at different times than those represented by the input, values at different locations or areas than those represented by the input, etc) as output. In some embodiments, the machine learning model may receive additional information as input to accompany the interpolated values, including but not limited to environmental information associated with the geographical area at the time the sampling data was collected (e.g., temperature, precipitation, wind speed, air quality, etc.), information regarding the sampling devices used (e.g., an identification of the type of sampling device, an identification of the configuration of the sampling device, an amount of time for which the sampling device was deployed, etc.), and an identity of a researcher who collected data from the sampling devices. In some embodiments, the machine learning model generates a predicted value as output along with a confidence score that indicates a level of uncertainty in the predicted value.

At block 314, the model training engine 220 evaluates the predictions using a corresponding subset of values of the variance map. In a traditional training technique, the predictions of the machine learning model would be compared directly with the input values (or at least a test set of values withheld from the training data) in order to evaluate the performance of the machine learning model and to adjust the weights of the parameters of the machine learning model (e.g., via gradient descent) in order to improve the performance. However, in the method 300, the noise that is likely present in the sampling data would make a direct comparison ineffective in improving the performance of the machine learning model. Accordingly, instead of a direct comparison of the predicted value to a ground truth value, the model training engine 220 uses a variance value from the variance map to increase or decrease the penalty applied to a mismatch between the predicted value and the ground truth value from the interpolated value map. For example, if the mean value indicated by the interpolated value map is far from the predicted value generated by the machine learning model, but the variance at the associated location in the variance map is high, the performance of the machine learning model will not be penalized as much for the mismatch compared to if the variance at the associated location in the variance map was low. Any suitable technique for using the variance map to adjust the penalty may be used, including but not limited to using a log-likelihood comparison. The log-likelihood comparison may compare the mean value from the interpolated value map and the associated variance from the variance map to the predicted value and the confidence score from the machine learning model.

At block 316, the model training engine 220 updates the machine learning model based on the evaluations of the predictions. Any suitable technique may be used to update the machine learning model, including but not limited to gradient descent techniques that include determining a gradient of the loss function and backpropagating the error through the weights of the machine learning model.

The method 300 then proceeds to a decision block 318, where a determination is made regarding whether the method 300 is done updating the machine learning model. In some embodiments, the performance of the machine learning model may be compared to a threshold performance value, and the determination of whether the method 300 is done may be based on whether the performance of the machine learning model has reached the threshold. In some embodiments, the determination of whether the method 300 is done may be based on whether the performance of the machine learning model has converged to a local or global minimum such that further iterations would not further improve performance. In some embodiments, the determination of whether the method 300 is done may be based on whether a predetermined number of iterations have been performed.

If it is determined that the method 300 is not done updating the machine learning model, then the result of decision block 318 is NO, and the method 300 returns to block 312 for a subsequent optimization iteration. Otherwise, if it is determined that the method 300 is done updating the machine learning model, then the result of decision block 318 is YES, and the method 300 proceeds to block 320.

At block 320, the model training engine 220 stores the trained machine learning model in a model data store 214 of the noisy training computing system 210.

At block 322, a prediction engine 222 of the noisy training computing system 210 uses the trained machine learning model to generate a prediction of a value in the geographical area. In some embodiments, the trained machine learning model may be used to generate a value map that indicates predicted values within the geographical area at a time other than the time covered by the sampling data. In some embodiments, the trained machine learning model may be provided with new sampling data as input, and the trained machine learning model may make predictions using the new sampling data (assuming that the covariance between the sampling devices that existed during the collection of the original sampling data remains relatively constant).

In some embodiments, the prediction engine 222 may provide a user interface. The user interface may present the geographical area for which the trained machine learning model was trained. The user interface may accept input from a user that indicates a location within the geographical area and/or a time at which to generate a prediction. The prediction engine 222 may then provide the input from the user as input to the trained machine learning model, and may return the output prediction to the user. In some embodiments, the user interface may allow the user to provide and/or change any of the inputs to the trained machine learning model, including but not limited to one or more input sample values, environmental conditions, or any of the other inputs on which the trained machine learning model was trained.

The method 300 then proceeds to an end block and terminates.

Though the techniques described above were discussed primarily in relation to species population sampling data, one of ordinary skill in the art will recognize that other types of data may be processed by these techniques, which are particularly useful for any type of noisy sampled data. For example, other types of ecological data may be processed using these techniques. As another example, data other than ecological data may be processed using these techniques.

In the preceding description, numerous specific details are set forth to provide a thorough understanding of various embodiments of the present disclosure. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The order in which some or all of the blocks appear in each method flowchart should not be deemed limiting. Rather, one of ordinary skill in the art having the benefit of the present disclosure will understand that actions associated with some of the blocks may be executed in a variety of orders not illustrated, or even in parallel.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A computer-implemented method of training and using a machine learning model, the method comprising:
receiving, by a computing system, a plurality of sampling data values for a geographical area;
creating, by the computing system, an interpolated value map and a variance map for the geographical area using the plurality of sampling data values;
training, by the computing system, a machine learning model using values of the interpolated value map as ground truth values and evaluating performance of the machine learning model using the variance map; and
storing, by the computing system, the trained machine learning model in a model data store.

2. The computer-implemented method of claim 1, further comprising:
generating, by the computing system, a predicted value for the geographical area using the trained machine learning model.

3. The computer-implemented method of claim 2, further comprising:
receiving, by the computing system, one or more input values from a user interface;
wherein generating the predicted value for the geographical area using the trained machine learning model includes providing the one or more input values received from the user interface as input to the trained machine learning model.

4. The computer-implemented method of claim 1, wherein creating the interpolated value map and the variance map includes performing kriging over at least a portion of the plurality of sampling data values to generate both the interpolated value map and the variance map.

5. The computer-implemented method of claim 1, wherein evaluating performance of the machine learning model using the variance map includes:
determining a difference between a value predicted by the machine learning model and a corresponding ground truth value of the interpolated value map; and
weighting the difference by a variance value of the variance map corresponding to the ground truth value of the interpolated value map.

6. The computer-implemented method of claim 5, wherein determining the difference between the value predicted by the machine learning model and the corresponding ground truth value of the interpolated value map, and weighting the difference by the variance value of the variance map corresponding to the ground truth value of the interpolated value map includes performing a log-likelihood comparison.

7. The computer-implemented method of claim 1, wherein each sampling data value of the plurality of sampling data values includes a latitude, a longitude, and a timestamp.

8. The computer-implemented method of claim 1, wherein each sampling data value of the plurality of sampling data values includes a count value.

9. The computer-implemented method of claim 8, wherein the count value is a count of animals detected by a trap.

10. The computer-implemented method of claim 1, wherein training the machine learning model includes updating the machine learning model using gradient descent.

11. A non-transitory computer-readable medium having computer-executable instructions stored thereon that, in response to execution by one or more processors of a computing system, cause the computing system to perform actions for training and using a machine learning model, the actions comprising:
receiving, by the computing system, a plurality of sampling data values for a geographical area;
creating, by the computing system, an interpolated value map and a variance map for the geographical area using the plurality of sampling data values;
training, by the computing system, a machine learning model using values of the interpolated value map as ground truth values and evaluating performance of the machine learning model using the variance map; and
storing, by the computing system, the trained machine learning model in a model data store.

12. The non-transitory computer-readable medium of claim 11, wherein the actions further comprise:
generating, by the computing system, a predicted value for the geographical area using the trained machine learning model.

13. The non-transitory computer-readable medium of claim 12, wherein the actions further comprise:
receiving, by the computing system, one or more input values from a user interface;
wherein generating the predicted value for the geographical area using the trained machine learning model includes providing the one or more input values received from the user interface as input to the trained machine learning model.

14. The non-transitory computer-readable medium of claim 11, wherein creating the interpolated value map and the variance map includes performing kriging over at least a portion of the plurality of sampling data values to generate both the interpolated value map and the variance map.

15. The non-transitory computer-readable medium of claim 11, wherein evaluating performance of the machine learning model using the variance map includes:
determining a difference between a value predicted by the machine learning model and a corresponding ground truth value of the interpolated value map; and
weighting the difference by a variance value of the variance map corresponding to the ground truth value of the interpolated value map.

16. The non-transitory computer-readable medium of claim 15, wherein determining the difference between the value predicted by the machine learning model and the corresponding ground truth value of the interpolated value map, and weighting the difference by the variance value of the variance map corresponding to the ground truth value of the interpolated value map includes performing a log-likelihood comparison.

17. The non-transitory computer-readable medium of claim 11, wherein each sampling data value of the plurality of sampling data values includes a latitude, a longitude, and a timestamp.

18. The non-transitory computer-readable medium of claim 11, wherein each sampling data value of the plurality of sampling data values includes a count value.

19. The non-transitory computer-readable medium of claim 18, wherein the count value is a count of animals detected by a trap.

20. The non-transitory computer-readable medium of claim 11, wherein training the machine learning model includes updating the machine learning model using gradient descent.
